(19) United States
(12) Patent Application Publication
(10) Pub. No.: US 2011/0020734 A1
(43) Pub. Date: Jan. 27, 2011

(54) LIQUID TANK, FUEL CELL AND ELECTRONIC APPARATUS

(75) Inventors: Kazuaki Fukushima, Kanagawa (JP); Yoshiaki Inoue, Aichi (JP); Atsushi Sato, Kanagawa (JP); Yuto Takagi, Kanagawa (JP); Jusuke Shimura, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/935,162

(22) PCT Filed: Mar. 25, 2009
(86) PCT No.: PCT/JP2009/055915

§ 371 Date: Sep. 28, 2010

(30) Foreign Application Priority Data
Apr. 4, 2008 (JP) P2008-098027

(51) Int. Cl. H01M 8/04; B65D 37/00

(52) U.S. Cl. 429/515; 222/206

(57) ABSTRACT

A fuel tank preventing an excessive supply when manually supplying a liquid such as a fuel, a fuel cell and an electronic apparatus using the fuel tank are provided. A fuel tank includes a deformable section which is deformable by external pressure in a part of a housing containing a liquid fuel. The deformable section has a projected shape outward from a top surface of the housing, and has a configuration in which a flat surface is arranged with a bending part in the top surface of the housing. The flat surface of the deformable section is pushed by a finger, a stick or the like to apply external pressure to the deformable section, thereby the deformable section is deformed so as to be flipped with respect to the top surface of the housing. The volumetric capacity in the housing is changed to push the liquid fuel out.

### CROSS REFERENCE TO RELATED APPLICATIONS

The present application is a National Stage of International Application No. PCT/JP2009/055915 filed on Mar. 25, 2009 and which claims priority to Japanese Patent Application No. 2008-098027 filed on Apr. 4, 2008, the entire contents of which are being incorporated herein by reference.

### BACKGROUND

The present disclosure relates to a liquid tank storing a fuel to be supplied to a power generation section, a fuel cell and an electronic apparatus.

A fuel cell has a configuration in which an electrolyte is arranged between a fuel electrode (an anode electrode) and an oxygen electrode (a cathode electrode), and a fuel and an oxidizer are supplied to the fuel electrode and the oxygen electrode, respectively. At this time, the fuel and the oxidizer are oxidized and reduced, and chemical energy of the fuel is converted into electrical energy to extract the electrical energy. The fuel is supplied from a fuel tank to the fuel electrode with use of an accessory such as a pump.

Such a fuel cell is used in combination with an auxiliary power source such as a storage battery, for example, a lithium-ion battery or a capacitor. For example, upon activation of the fuel cell, electric power corresponding to necessary electric power for an accessory such as a pump is supplied from the auxiliary power source, thereby a fuel is supplied to a power generation section so as to generate electric power. The electric power generated in such a manner is outputted to a drive apparatus (a load), and surplus power is stored in the auxiliary power source. Moreover, under a high load, electric power is outputted from the auxiliary power source to the drive apparatus. When the auxiliary power source is provided, electric power is allowed to be supplied to an activation device until the fuel cell generates electric power, and the fuel cell is allowed to generate constant electric power, so use efficiency is allowed to be improved.

However, the voltage of the auxiliary power source may decline due to an excessive power consumption of the auxiliary power source by high-load use of the drive apparatus, self-discharge in the case where the fuel cell is not used for a long time, or the like.

In the case where the auxiliary power source is exhausted in such a manner, the pump is not activated, thereby electric power is not extracted from the fuel cell. Patent Documents 1 and 2 disclose a fuel cell system which supplies a fuel to a fuel cell built in an electronic apparatus or the like with use of a manual pump.

[Patent Document 1] Japanese Unexamined Patent Application Publication No. 2005-19371

[Patent Document 2] Japanese Unexamined Patent Application Publication No. 2007-80731

### SUMMARY

However, in a configuration in the above-described Patent Document 1, a pump is manually pushed to feed a fuel to a power generation section, so the amount of the supplied fuel depends on how the pump is pushed. Therefore, a larger amount of the fuel than necessary may be supplied with a single supply of the fuel, and as a result, there is such an issue that a failure such as fuel leakage occurs. Moreover, in a configuration in Patent Document 2, an attempt is made to keep the amount of the fuel to be supplied within a predetermined amount by arranging a sub-tank, but the configuration is complicated by, for example, needing a pump supplying the fuel to the sub-tank, so the configuration is disadvantageous for downsizing.

The present embodiments provide a liquid tank allowed to prevent an excessive supply of a liquid such as a fuel when manually supplying the liquid, and a fuel cell and an electronic apparatus using the liquid tank.

In an embodiment, a liquid tank includes: a housing containing a liquid and having an outlet for feeding the liquid to outside; a deformable section arranged in at least a part of the housing and being deformable by external pressure; and a restriction means for restricting a deformation amount of the deformable section not to exceed a certain amount.

In an embodiment, a fuel cell includes a power generation section and the above-described liquid tank.

In an embodiment, an electronic apparatus mounts the above-described fuel cell.

In the liquid tank, the fuel cell and the electronic apparatus of the embodiments, in the fuel tank, when the deformable section which is deformable by external pressure is pushed by, for example, a finger or the like, the volumetric capacity of the housing is reduced to push a liquid contained in the housing out of the outlet of the housing to outside. At this time, the volumetric capacity change amount of the housing is restricted by the restriction means not to exceed a certain amount.

According to the liquid tank, the fuel cell and the electronic apparatus of the embodiments, a part of the housing containing a liquid is a deformable section which is deformable, and the restriction means is arranged so that the deformation amount of the deformable section does not exceed a certain amount, so even if the deformable section is pushed by a finger or the like to manually supply the liquid, an excessive supply of the liquid is preventable.

Additional features and advantages are described herein, and will be apparent from, the following Detailed Description and the figures.

### BRIEF DESCRIPTION OF THE FIGURES

FIG. 1 is a sectional view illustrating a schematic configuration of a fuel tank according to a first embodiment.

FIG. 2 is a diagram illustrating a schematic configuration of a fuel cell using the fuel tank illustrated in FIG. 1.

FIG. 3 is a sectional view illustrating a schematic configuration of the fuel cell illustrated in FIG. 2

FIG. 4 is an illustration of a whole configuration of a fuel cell system using the fuel cell illustrated in FIG. 2.

FIG. 5 is a sectional view illustrating a schematic configuration of a fuel tank according to a modification example of the first embodiment.

FIG. 6 is a sectional view illustrating a schematic configuration of a fuel tank according to a second embodiment.

FIG. 7 is an illustration of an internal configuration of the fuel tank illustrated in FIG. 5.

FIG. 8 is a sectional view illustrating a schematic configuration of a fuel tank according to a modification example of the second embodiment.

FIG. 9 is a sectional view illustrating a schematic configuration of a fuel tank according to a third embodiment.

FIG. 10 is a sectional view illustrating a schematic configuration of a fuel tank according to a modification example of the third embodiment.

FIG. 11 is an illustration of an appearance of an electronic apparatus according to an application example of the fuel cell illustrated in FIG. 2.

### DETAILED DESCRIPTION

Embodiments will be described in detail below referring to the accompanying drawings.

### First Embodiment

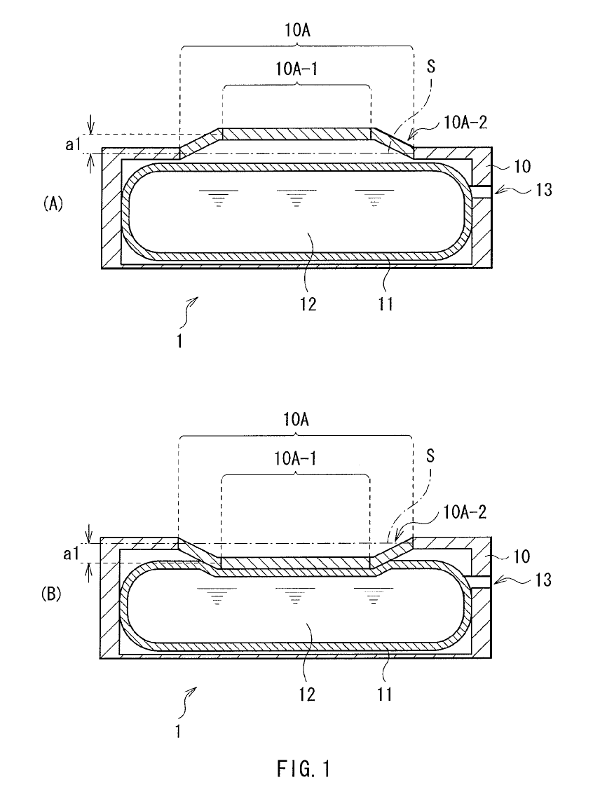

FIGS. 1(A) and 1(B) illustrate a sectional configuration of a fuel tank 1 according to a first embodiment. The fuel tank 1 stores a fuel to be supplied to a power generation section of a fuel cell, and contains, for example, a liquid fuel 12 such as methanol in a housing 10. A valve (an outlet) 13 for feeding the liquid fuel 12 to the power generation section is arranged on a side surface of the housing 10.

The outside shape of the housing 10 is, for example, a rectangular parallelepiped shape, and is made of a metal material such as aluminum (Al) or stainless steel (SUS), or a resin material such as PET (polyethylene terephthalate) or polypropylene. The liquid fuel 12 enclosed in a package container 11 is contained in the housing 10. The package container 11 is, for example, a pouched container made of an aluminum-laminated film or the like.

The housing 10 has a deformable section 10A which is deformable by pressure from outside (hereinafter simply referred to as external pressure). The deformable section 10A is molded so that a part of the housing 10 is projected outward (refer to FIG. 1(A)), and is configured to have a flat part 10A-1 with a bending part 10A-2 in a top surface S of the housing 10. The flat part 10A-1 is a part to be pushed by a finger, a stick or the like. Moreover, such a deformable section 10A may be molded, for example, by subjecting a surface of the housing 10 to stamping.

The shape of the deformable section 10A, that is, a height a1 from the top surface S of the housing 10 of the flat part 10A-1, plane areas of the flat section 10A-1 and the bending part 10A-2, and the like are designed so that the deformable amount of the deformable section 10A does not exceed a certain amount. For example, as illustrated in the following expression (1), the deformable section 10A is designed so that the volumetric capacity change amount of the housing 10 by deformation of the deformable section 10A does not exceed a dangerous liquid feeding amount, or if a flow path (which will be described later) connecting from a fuel tank to a power generation section is present, the volumetric capacity change amount of the housing 10 does not exceed an amount obtained by subtracting the volumetric capacity of the flow path from the dangerous feeding amount. Alternatively, as illustrated in the following expression (2), the deformable section 10A is designed so that the volumetric capacity change amount of the housing 10 exceeds a necessary amount of methanol for a fuel cell system to steadily operate.

(Volumetric capacity change amount)<(Dangerous liquid feeding amount)−(Volumetric capacity of flow path) (1)

(Volumetric capacity change amount)>(Necessary amount of methanol to steadily generate electric power) (2)

In the above-described fuel tank 1, when external pressure is applied to the flat part 10A-1 of the deformable section 10A of the housing 10, for example, by pushing the flat part 10A-1 by a finger or the like, the bending part 10A-2 is flipped toward the inside of the housing 10 so as to dent the housing 10 (refer to FIG. 1(B)). Thereby, the volumetric capacity in the housing 10 is reduced, and the package container 11 is crushed to push the liquid fuel 12 enclosed in the package container 11 out of the valve 13.

At this time, the deformable section 10A is configured of, for example, the flat part 10A-1 and the bending part 10A-2, and is designed so that the deformable section 10A is flipped toward the inside of the housing 10 by external pressure and the deformation amount of the deformable section 10A does not exceed a certain amount, thereby the volumetric capacity change amount of the housing 10 is limited irrespective of the magnitude of the external pressure applied to the flat part 10A. Moreover, once the deformable section 10A is deformed, the deformable section 10A is resistant to restoring its original shape, so after the fuel is manually supplied once, the fuel is not allowed to be supplied successively.

Thus, in the fuel tank 1, the deformable section 10A which is deformable is included in the housing 10 containing the liquid fuel 12, and the deformation amount of the deformable section 10A does not exceed a certain amount, so even if the liquid fuel 12 is manually supplied, an excessive supply of the liquid fuel 12 to the power generation section is preventable.

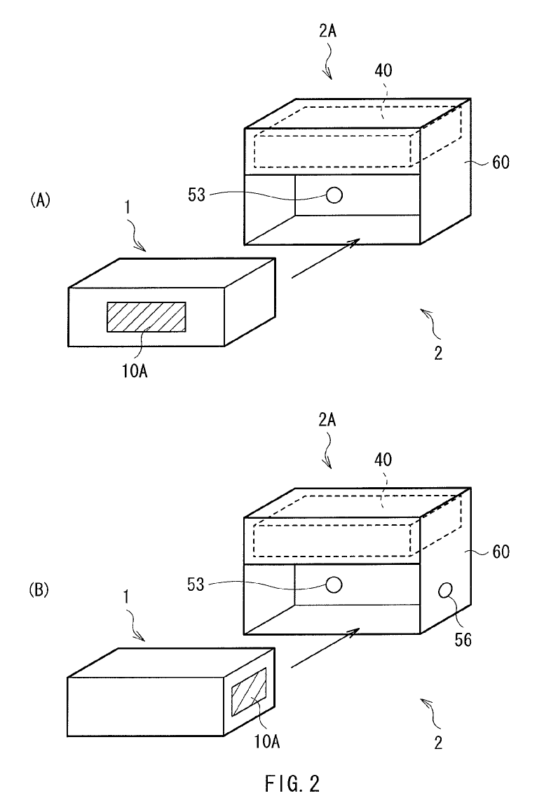

Moreover, the above-described fuel tank 1 is preferably applicable to, for example, a fuel cell 2 illustrated in the following FIGS. 2(A) and 2(B).

The fuel cell 2 is a direct methanol fuel cell generating electric power by a reaction between methanol and oxygen, and is configured of a fuel cell body 2A and the fuel tank 1 which is removably mounted in the fuel cell body 2A.

The fuel cell body 2A contains a power generation section 40 in an exterior member 60, and has a space for containing the fuel tank 1. The exterior member 60 is made of, for example, a metal material such as stainless steel or aluminum, or a resin material such as PET (polyethylene terephthalate) or polypropylene. A connector 53 for connecting to the fuel tank 1 is arranged inside the exterior member 60. A tube for valve connection inserted into the valve 13 of the fuel tank 1 is installed in the connector 53, and is communicated with a flow path 52 (which will be described later) for supplying the liquid fuel 12 fed from the fuel tank 1 toward the power generation section 40 which will be described later.

The fuel tank 1 is mounted in the above-described fuel cell body 2A in a state where the deformable section 10A is exposed from the above-described fuel cell body 2A (refer to FIG. 2(A)) or in a state where the deformable section 10A is not exposed to outside (refer to FIG. 2(B)). In particular, in a configuration in FIG. 2(B), a through window 56 is arranged in a region corresponding to the deformable section 10A of the exterior member 60, and external pressure is applied to the deformable section 10A through the through window 56. Thereby, an error such as accidentally pushing the deformable section 10A is preventable, and safety is further improved. In addition, the fuel tank 1 may be replaceable in the fuel cell body 2A, or may be built in the fuel cell body 2A.

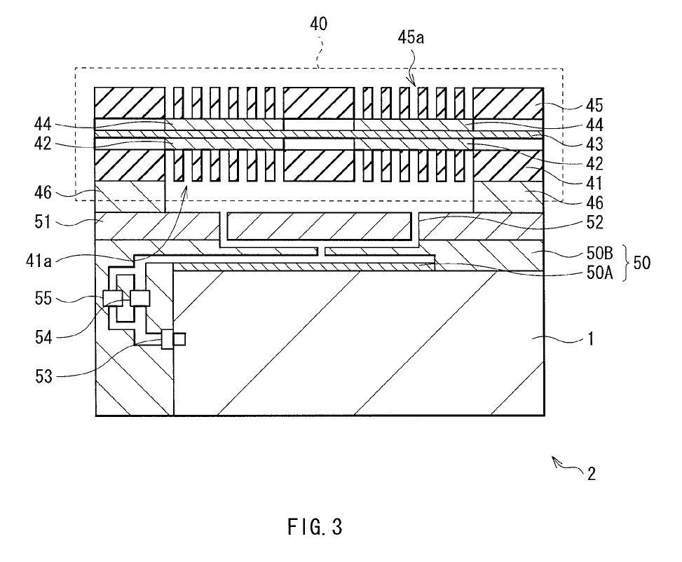

FIG. 3 illustrates a sectional configuration of the fuel cell 2 in which the fuel tank 1 is mounted. In the fuel cell 2, a pump 50 and a fuel vaporization section 51 are arranged between the power generation section 40 and the fuel tank 1, and are connected to each other through the flow path 52. The power generation section 40 and the fuel vaporization section 51 are sealed with a sealing layer 46.

The power generation section 40 has a configuration in which one or a plurality of unit cells including a fuel electrode 42 and an oxygen electrode 44 are sandwiched between cell plates 41 and 45. The cell plates 41 and 45 are fixing members which fix the positions of the fuel electrode 42 and the oxygen electrode 44 of the power generation section 40, and are made of, for example, stainless steel, aluminum or the like. The cell plate 41 has a through hole 41a for allowing a fuel to pass therethrough, and the cell plate 45 has a through hole for allowing air (oxygen) as an oxidizer to pass therethrough.

The fuel electrode 42 and the oxygen electrode 44 have a configuration in which a catalyst layer including a catalyst such as platinum (Pt) or ruthenium (Ru) is formed on a diffusion member made of, for example, a carbon paper or the like. The catalyst layer is configured by dispersing a supporting body such as carbon black which supports a catalyst into a polyperfluoroalkyl sulfonic acid-based proton-conducting material. In addition, an air supply pump (not illustrated) may be connected to the oxygen electrode 44.

The electrolyte film 43 is made of, for example, a proton-conducting material having a sulfonic acid group (—SO₃H). As the proton-conducting material, a polyperfluoroalkyl sulfonic acid-based proton-conducting material (for example, “Nafion (trademark)” manufactured from DuPont), a hydrocarbon-based proton-conducting material such as polyimide sulfonic acid, a fullerene-based proton-conducting material or the like is used.

The pump 50 is configured of, for example, a piezoelectric body 50A and a supporting body 50B for the piezoelectric body 50A, and has a function of sucking up the liquid fuel 12 contained in the fuel tank 1. The pump 50 operates mainly by electric power supply from an auxiliary power source (not illustrated) during steady operation.

The fuel vaporization section 51 is arranged below the cell plate 41 to face the through hole 41a, and is configured of a fuel diffusion plate diffusing and vaporizing a fuel sucked up by the pump 50. The liquid fuel 12 is diffused and vaporized in the fuel vaporization section 51, and is supplied to the fuel electrode 42 through the through hole 41a of the cell plate 41.

In this case, an active valve 54 is arranged in the flow path 52 from the fuel tank 1 to the pump 50, and a release valve 55 is arranged in a path branched from the flow path 52. In normal times, the active valve 54 is in an open state and the release valve 5 is in a close state. However, the release valve 55 is allowed to be manually opened and closed, and is used when the active valve 54 is in a close state, that is, in case of such emergency that accessories are not activated.

The fuel cell 2 is manufacturable by, for example, the following manner.

First, the power generation section 40 is formed. First, the electrolyte film 43 made of the above-described material is sandwiched between the fuel electrode 42 and the oxygen electrode 44 made of the above-described materials, and they are bonded by thermocompression bonding to be arranged in series with use of a current collector such as a metal mesh (not illustrated) and a gasket. Next, the cell plates 41 and 45 made of the above-described material are prepared, and are arranged on a side facing the fuel electrode 42 and on a side facing the oxygen electrode 44, respectively. Thereby, the power generation section 40 is formed.

Next, the power generation section 40 is contained in the exterior member 60 made of the above-described material, and the flow path 52 is arranged between the power generation section 40 and the connector 53 through the fuel vaporization section 51 and the pump 50. Thereby, the fuel cell body 2A is completed.

The fuel tank 1 is mounted in the fuel cell body 2A completed in such a manner. More specifically, the fuel tank 1 is mounted in the fuel cell body 2A by inserting the valve 13 of the fuel tank 1 into a tube for valve connection of the connector 53 of the fuel cell body 2A. Thus, the fuel cell 2 illustrated in FIGS. 2 and 3 is completed.

Next, functions and effects of the above-described fuel cell 2 will be described below.

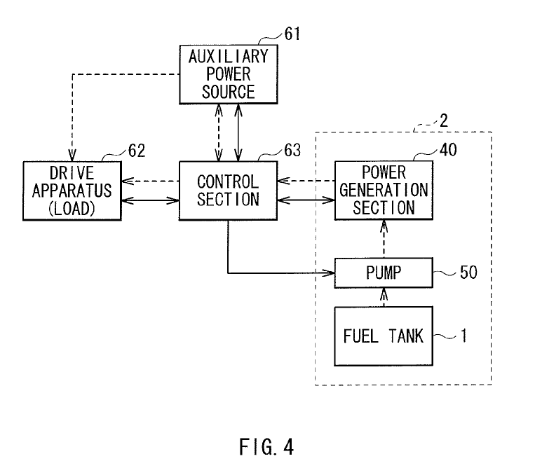

Here, FIG. 4 illustrates an example of a fuel cell system to which the fuel cell 2 is applied. In the fuel cell system, electric power corresponding to necessary electric power for the power generation section 40 and the pump 50 upon activation is supplied from an auxiliary power source 61 in response to control by a control section 63, and the liquid fuel 12 contained in the fuel tank 1 is sucked up by the pump 50. The sucked liquid fuel 12 is diffused and vaporized in the fuel vaporization section 51 (not illustrated in FIG. 4) to be supplied to the fuel electrode 42 of the power generation section 40.

On the other hand, oxygen is supplied to the oxygen electrode 44 through the through hole 45a of the cell plate 45. Thereby, an oxidation-reduction reaction occurs between the fuel electrode 42, the electrolyte film 43 and the oxygen electrode 44, and chemical energy of the fuel is converted into electrical energy, and the electrical energy is extracted as electric power. The electric power generated in the power generation section 40 in such a manner is outputted to a drive apparatus 62 in response to control by the control section 63, and the auxiliary power source 61 is responsible for an excess and a shortfall of the electric power. In other words, in the case where surplus power is generated, the auxiliary power source 61 stores the surplus power, and a shortfall of electric power is covered by the auxiliary power source 61 under a high load of the drive apparatus 62, and the auxiliary power source 61 outputs electric power corresponding to the shortfall to the drive apparatus 62.

However, in the case where the above-described auxiliary power source 61 is exhausted, upon activation, the pump 50 does not operate, and the supply of the liquid fuel 12 stops, and electric power is not extracted.

In such a case, when the deformable section 10A of the fuel tank 1 is pushed by a finger, a stick or the like, as described above, the liquid fuel 12 contained in the fuel tank 1 is supplied to the power generation section 40. Therefore, in case of emergency such as the case where the pump 50 is not activated due to exhaustion of the auxiliary power source 61, or the like, electric power is allowed to be extracted manually. Moreover, in the case where the active valve 54 is closed, the release valve 55 is manually turned to an open state, thereby the liquid fuel 12 is allowed to be fed to the power generation section 40.

### Modification Example 1

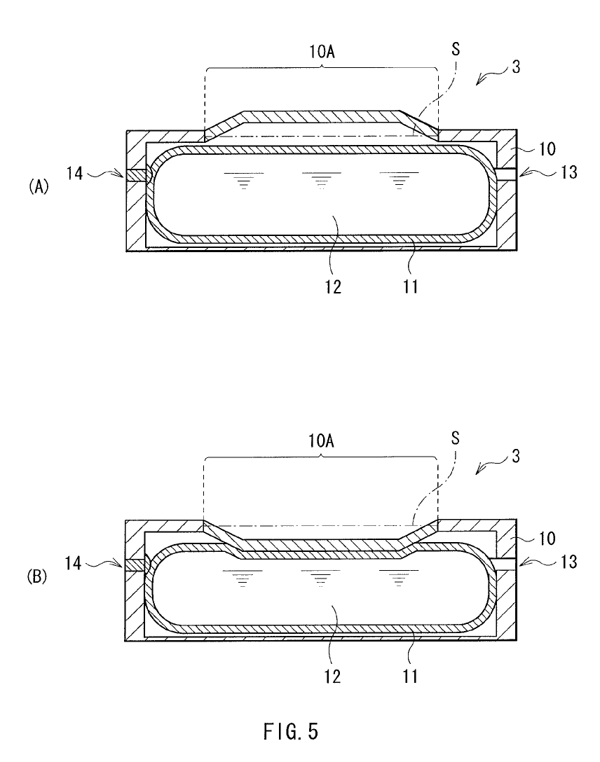

FIGS. 5(A) and 5(B) illustrate a sectional configuration of a fuel tank 3 according to a modification example of the above-described fuel tank 1. The fuel tank 3 has the same configuration as that of the above-described fuel tank 1, except that an air intake 14 is arranged on a side surface of a housing. Therefore, like components are denoted by like numerals as of the above-described fuel tank 1 and will not be further described.

The air intake 14 is arranged so as to take air into the housing 10 for adjustment of internal pressure in the housing 10. A check valve (not illustrated) confining the flow of air and the liquid fuel 12 in one direction is arranged in the air intake 14. The check valve prevents backflow of the liquid fuel 12 while taking air therein, and is made of, for example, a silicone resin.

In the fuel tank 3, in the case where the deformable section 10A is deformed as illustrated in FIG. 5(B) from a state illustrated in FIG. 5(A) by pushing the deformable section 10A by a finger or the like to apply external pressure, the check valve of the air intake 14 is closed, thereby the internal pressure in the housing 10 is increased to discharge a fuel from the package container 11. Moreover, when the check valve of the air intake 14 is opened, the deformable section 10A is allowed to restore the state illustrated in FIG. 5(A) again. Therefore, when the air intake 14 is arranged, the fuel is allowed to be manually supplied repeatedly. Moreover, when the bore of the air intake 14 is adjusted, time necessary for the deformable section 10A which is once deformed to restore its original shape again is controllable. For example, when the bore of the air intake 14 is reduced, necessary time for the deformable section 10A to restore its original shape is allowed to be set long. Thus, an excessive supply of a fuel by successive supplies is preventable.

### Second Embodiment

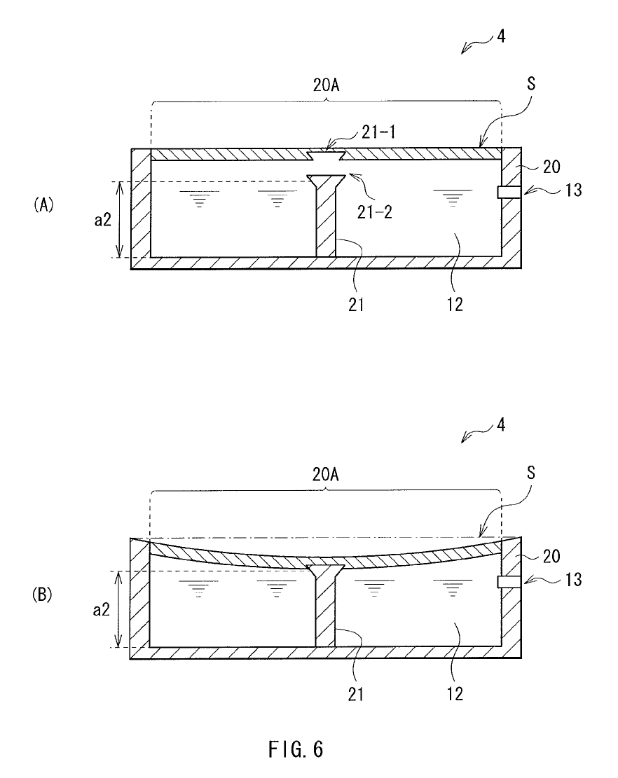

FIGS. 6(A) and 6(B) illustrate a sectional configuration of a fuel tank 4 according to a second embodiment. The fuel tank 4 has the same configuration as that of the fuel tank 1 according to the above-described first embodiment, except for the configuration of a deformation section 20A arranged in a top surface of a housing 20. Therefore, like components are denoted by like numerals as of the above-described fuel tank 1 and will not be further described.

In the fuel tank 4, the liquid fuel 12 is directly injected into the housing 20, and the fuel tank 4 includes the deformable section 20A in a top surface S of the housing 20, and a projection (a restriction member) 21 in the housing 20. An engaging section 21-2 with an inverted truncated cone shape is arranged at a tip of the restriction member 21, and a groove section (an engaging section 21-1) with the same shape as the engaging section 21-2 is arranged on an inner surface of the deformable section 20A corresponding to the engaging section 21-2.

The deformable section 20A is molded as one unit with the housing 20, and is made of a material having a property of bending toward the inside of the housing 20 by external pressure, for example, a polyester material such as PET (polyethylene terephthalate), or a high methanol-resistant resin such as polyacrylonitril, COC (cyclo olefin copolymer) or polypropylene. Moreover, to improve methanol barrier properties, it is desirable to combine and use an evaporation layer such as alumina or silica, or aluminum foil with the above-described material.

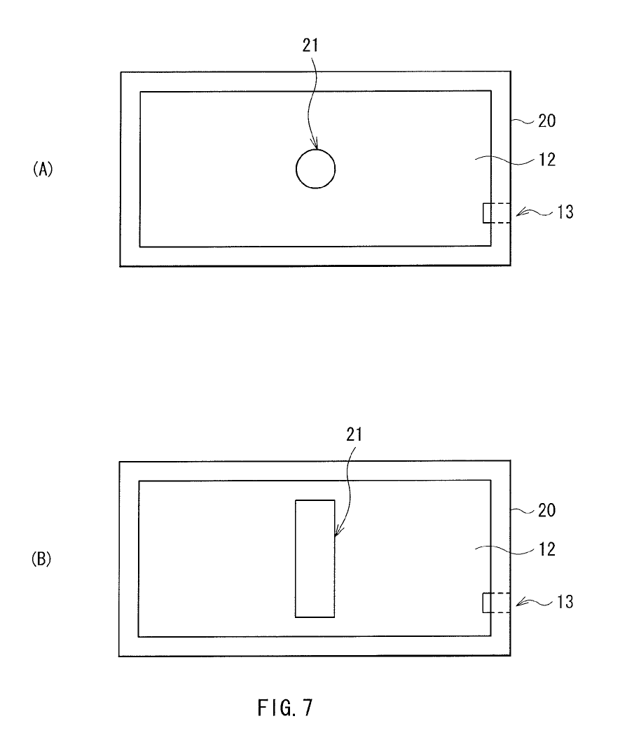

The restriction member 21 is arranged to face a central position of the deformable section 20A. The restriction member 21 is made of, for example, the same material as that of the housing 20, and may have, for example, a cylindrical shape as illustrated in FIG. 7(A) or a rectangular parallelepiped shape as illustrated in FIG. 7(B). Note that FIGS. 7(A) and 7(B) illustrate an internal configuration of the housing 20 viewed from the deformable section 20A.

The plane area of such a deformable section 20A, a height a2 of the restriction member 21, and the like are designed so that the deformation amount of the deformable section 20A does not exceed a certain deformation amount so as to satisfy the above-described expressions (1) and (2) as in the case of the deformable section 10A of the above-described first embodiment.

In such a fuel tank 4, when the deformable section 20A in a state illustrated in FIG. 6(A) is deformed as illustrated in FIG. 6(B) by pushing the deformable section 20A by a finger or the like to apply external pressure, the deformable section 20A is bent toward the inside of the housing 20 to a tip position of the restriction member 21. Thus, since the deformable section 20A which is deformed by external pressure so as to be bent is arranged, as in the case of the fuel tank 1 of the above-described first embodiment, the volumetric capacity of the housing 20 is changed, thereby the liquid fuel 12 is allowed to be pushed out of the valve 13. Moreover, at this time, when the restriction member 21 with a predetermined height a2 is arranged inside the housing 20, bending (deformation) of the deformable section 20A is restricted at the tip position of the restriction member 21 so that the liquid fuel 12 is not excessively supplied. Therefore, the same effects as those in the above-described first embodiment are obtainable.

Moreover, when the engaging section 21-1 and the engaging section 21-2 are arranged in the deformable section 20A and at the tip of the restriction member 21, respectively, in the case where the deformable section 20A is bent by external pressure, a groove part of the engaging section 21-1 of the deformable section 20A is widened to be fit and fixed on the engaging section 21-2 of the restriction member 21. Thereby, the restoring characteristics for the shape of the deformable section 20A are eliminated, and a fuel is not allowed to be successively supplied after the fuel is manually supplied once.

In addition, in the above-described second embodiment, a configuration in which a whole top surface of the housing 20 is deformed so as to be bent is described as an example, but the whole surface may not be deformed, and the housing 20 may be configured so that only a partial region of the surface is bent.

### Modification Example 2

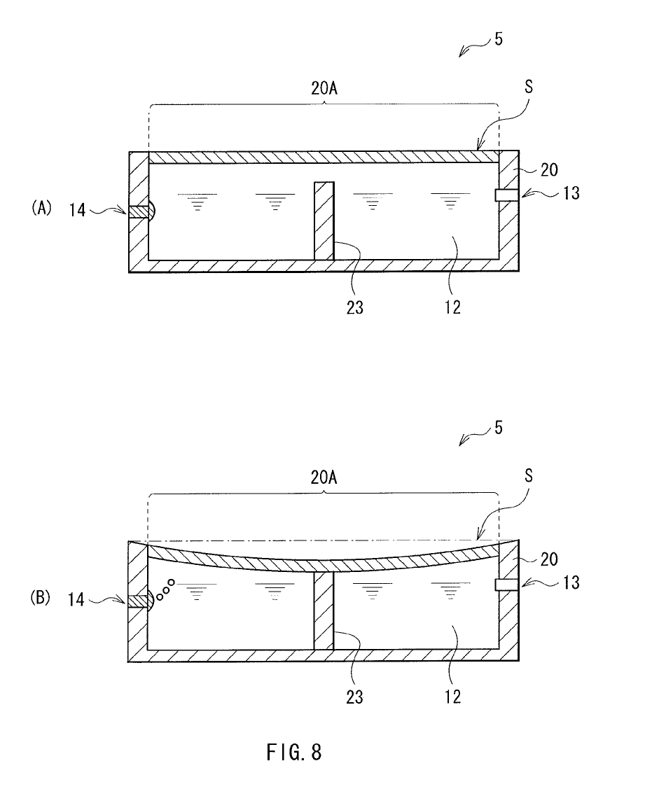

FIGS. 8(A) and 8(B) illustrate a sectional configuration of a fuel tank 5 according to a modification example of the fuel tank 4 according to the above-described second embodiment. The fuel tank 5 includes the air intake 14 of the fuel tank 3 according to the above-described Modification Example 1 on a side surface of the housing 20 of the above-described fuel tank 4. However, the fuel tank 5 has a configuration in which the engaging sections 21-1 and 21-2 in the above-described fuel tank 4 are not arranged in the deformable section 20A and the restriction member 23 in the fuel tank 5.

In the fuel tank 5, in the case where the deformable section 20A in a state illustrated in FIG. 8(A) is deformed as illustrated in FIG. 8(B) by pushing the deformable section 20A by a finger or the like to apply external pressure, when the check valve of the air intake 14 is closed, the internal pressure of the housing 10 is increased to discharge a fuel. Moreover, when the check valve of the air intake 14 is opened to take air therein, the deformable section 20A is allowed to restore the state illustrated in FIG. 8(A) again. Therefore, when the air intake 14 is arranged, a fuel is allowed to be manually supplied repeatedly. At this time, as in the case of Modification Example 1 of the above-described first embodiment, when the bore of the air intake 14 is reduced, an excessive supply of a fuel by successive supplies is preventable.

### Third Embodiment

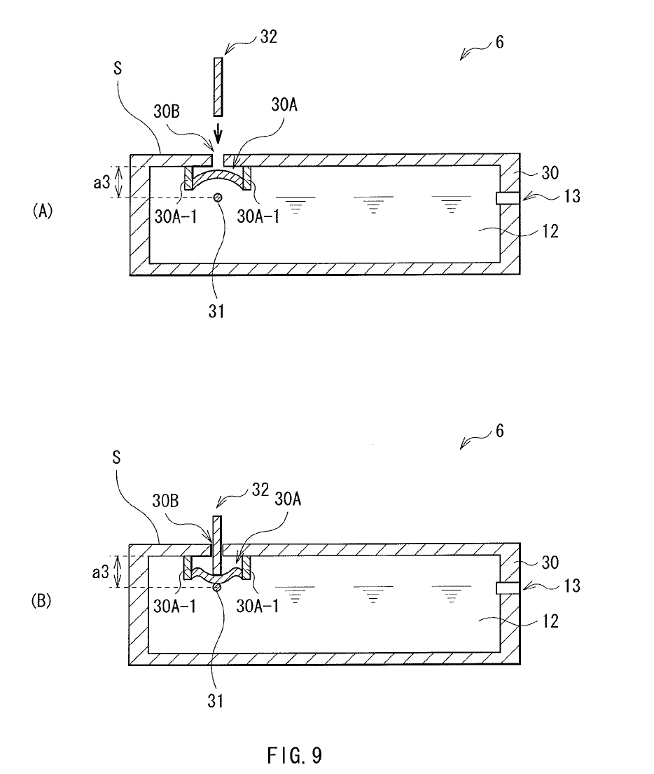

FIGS. 9(A) and 9(B) illustrate a sectional configuration of a fuel tank 6 according to a third embodiment. The fuel tank 6 has the same configuration as that of the fuel tank 4 according to the above-described second embodiment except for the configurations of a housing 30 and a deformable section 30A. Therefore, like components are denoted by like numerals as of the above-described fuel tank 4 and will not be further described.

In the fuel tank 6, the liquid fuel 12 is directly injected into the housing 30, and a through hole 30B for allowing, for example, a thinner push pin 32 or the like than a finger to pass therethrough is formed in a top surface S of the housing 30. The deformable section 30A is arranged inside the housing 30 to face the through hole 30B, and the housing 30 is sealed with a sealing layer 30A-1 formed along an edge of the deformable section 30A.

The deformable section 30A is made of a material having elasticity, for example, a dome-shaped flat spring using a metal material such as SUS or aluminum (a metal dome), and is arranged so that a dome-shaped convex surface faces the through hole 30B. A restriction member 31 is arranged to face the deformable section 30A.

The restriction member 31 is a stick-shaped member arranged on, for example, an inner side surface of the housing 30. Moreover, the restriction member 31 is arranged so that a longitudinal direction thereof is along an in-plane direction at a distance a3 from the top surface S of the housing 30, and a side part or a tip part of the restriction member 31 is arranged in front of the through hole 30B. The restriction member 31 is made of, for example, the same material as that of the housing 30.

The plane area of such a deformable section 30A, the height a3 from the top surface S of the restriction member 31, and the like are designed so that the deformation amount of the deformable section 30A does not exceed a certain deformation amount so as to satisfy the above-described expressions (1) and (2) as in the case of the deformable section 10A of the above-described first embodiment.

In the above-described fuel tank 6, as illustrated in FIG. 9(A), when the deformable section 30A is pushed by the push pin 32 through the through hole 30B to apply external pressure to the deformable section 30A, as illustrated in FIG. 9(B), the deformable section 30A is deformed so as to be dented toward the inside of the housing 30. Thereby, the volumetric capacity of the housing 30 is reduced. Therefore, as in the case of the fuel tank 1 of the above-described first embodiment, the liquid fuel 12 is allowed to be fed from the valve 13.

Moreover, at this time, when the restriction member 31 is arranged below the deformable section 30A in a position at the distance a3 from the top surface S of the housing 30, deformation toward the inside of the housing 30 of the deformable section 30A is restricted by the restriction member 31 so as to prevent an excessive supply of the liquid fuel 12. Therefore, the same effects as those in the fuel tank 1 of the above-described first embodiment are obtainable.

Further, the fuel tank 6 has a configuration in which the deformable section 30A is pushed by the push pin 32 or the like through the through hole 30B, so a malfunction in the deformable section 30A is preventable.

### Modification Example 3

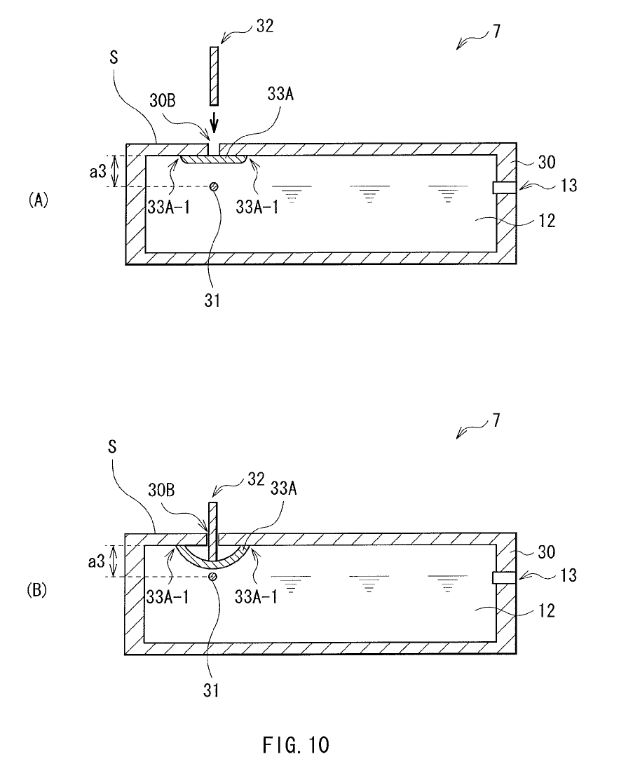

FIGS. 10(A) and 10(B) illustrate a sectional configuration of a fuel tank 7 according to a modification example of the fuel tank according to the third embodiment of the invention. The fuel tank 7 has the same configuration as that of the fuel tank 6 according to the above-described third embodiment except for the configuration of a deformable section 33A. Therefore, like components are denoted by like numerals as of the above-described fuel tank 6 and will not be further described.

The fuel tank 7 includes the deformable section 33A so as to be laid over the through hole 30B from the inside of the through hole 30B. An edge part 33A-1 of the deformable section 33A is fixed to the housing 30 so as to seal the housing 30.

The deformable section 33A is made of a material having elasticity, for example, a synthetic rubber material such as fluoro rubber, silicon rubber or ethylene-propylene rubber. The restriction member 31 is arranged to face the deformable section 33A. Moreover, the plane area of the deformable section 33A, a distance a3 from the top surface S of the restriction member 31, and the like are designed so that the deformation amount of the deformable section 33A does not exceed a certain deformation amount so as to satisfy the above-described expressions (1) and (2) as in the case of the deformable section 10A of the above-described first embodiment.

In the above-described fuel tank 7, as illustrated in FIG. 10(A), when the deformable section 33A is pushed by the push pin 32 through the through hole 30B to apply external pressure to the deformable section 33A, as illustrated in FIG. 10(B), the deformable section 33A is deformed so as to extend toward the inside of the housing 30. Thereby, the volumetric capacity of the housing 30 is reduced. Moreover, at this time, the volumetric capacity change amount of the housing 30 is restricted to a certain amount or less by the restriction member 31. Therefore, also in a configuration of such a modification example, the same effects as those in the fuel tank 6 according to the above-described third embodiment are obtainable.

### Application Examples

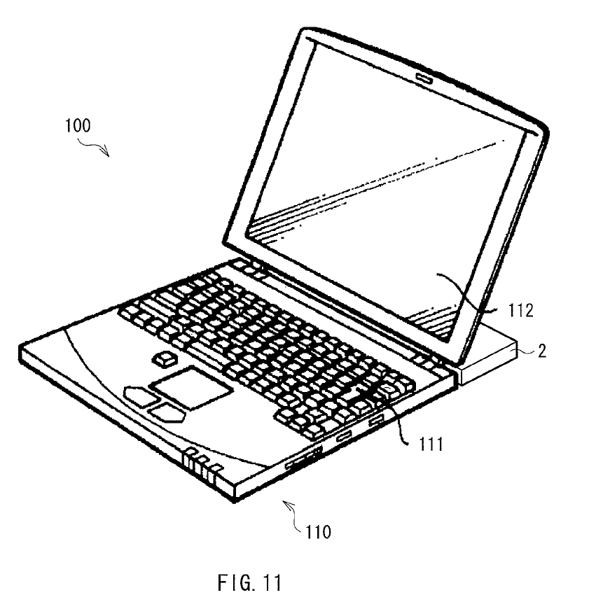

FIG. 11 illustrates an appearance of an electronic apparatus 100 mounting the fuel cell 2 described in the above-described first embodiment. The electronic apparatus 100 is, for example, a portable electronic apparatus including an apparatus body 110 which is, for example, a notebook personal computer and the fuel cell 2, and the apparatus body 110 is driven by electrical energy generated in the fuel cell 2.

The apparatus body 110 includes an input section 111 including a keyboard for operating an input of a character or the like and an openable display section 112 for displaying an image. Note that FIG. 11 illustrates a state in which the display section 112 is opened. The fuel cell 2 is mounted on a rear surface of the apparatus body 110.

In addition, the electronic apparatus mounting the fuel cell 2 is not only the above-described notebook personal computer but also any other electronic apparatus, for example, a portable electronic apparatus such as a cellular phone, an electrophotographic device, an electronic organizer, a camcorder, a portable game machine, a portable video player, a portable audio player or a PDA (Personal Digital Assistant).

In the above-described embodiments, an example in which the deformable section is arranged in the top surface of the housing is described, but the position of the deformable section is not limited to the top surface of the housing, and the deformable section may be arranged in any surface such as a bottom surface or a side surface of the housing.

Moreover, in the above-described embodiments, the case where only one surface of a plurality of surfaces of the housing with a rectangular parallelepiped shape is deformable is described as an example, but two or more surfaces of the housing may be deformable. However, in this case, the deformation amount of each deformable surface is controlled so that a change in volumetric capacity equal to or exceeding the dangerous liquid feeding amount does not occur as a whole.

Further, a surface in which the deformable section is arranged of the housing may be configured to be covered with a protective seal or the like, so that the deformable section is not allowed to be pushed in normal times. Thereby, if the seal is removed only in case of emergency to push the deformable section, a malfunction in the deformable section is preventable, and safety is further improved.

Moreover, in the above-described second and third embodiments, as an example of a restriction member for restricting the deformation amount of the housing, a projection is described, but the restriction member is not limited to the projection, and any other member may be used. Further, a configuration in which one projection is arranged to face a vicinity of the center of the deformable section is described as an example, but the number of projections may be two or more, and as long as the projection has such a configuration that a part thereof is allowed to control the deformation of the deformable section, the projection may be arranged at any other position in the housing.

Further, for example, the materials and thicknesses of constituent components, electric power generation conditions of the fuel cell, and the like are not limited to those described in the above-described embodiments, and the constituent components may be made of any other materials with any other thicknesses, and any other electric power generation conditions may be used. For example, the liquid fuel 12 may be any other liquid fuel such as ethanol or dimethyl ether in addition to methanol.

Moreover, the liquid tank is applicable to not only the fuel cell but also a fuel tank of an apparatus using a fuel for combustion such as kerosene, light oil or gasoline (such as a torch for illumination, a heater or an engine), an ink cartridge in an ink-jet printer, a spray gun, a perfume bottle, or the like.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-11. (canceled)

12. A liquid tank comprising:
a housing containing a liquid and having an outlet for feeding the liquid outside of said housing;
a deformable section arranged in at least a part of the housing and being deformable by external pressure; and
a restriction means for restricting a deformation amount of the deformable section so as not to exceed a certain deformation amount.

13. The liquid tank according to claim 12, wherein
the liquid is enclosed in a pouched container in the housing.

14. The liquid tank according to claim 13, wherein
the deformable section is a convex surface section projecting outwardly from one surface of the housing, and the convex surface section is deformed so as to be flipped toward an inside of the housing by external pressure.

15. The liquid tank according to claim 13, wherein
an intake for taking air in between an inner wall of the housing and the pouched container is arranged in the housing.

16. The liquid tank according to claim 12, wherein
the liquid is directly injected into the housing.

17. The liquid tank according to claim 12, wherein
the deformable section is deformed by external pressure so as to be bent toward the inside of the housing, and
a restriction member for restricting a bending amount of the deformable section so as not to exceed a certain bending amount and that is arranged inside the housing.

18. The liquid tank according to claim 17, wherein
the deformable section and the restriction member are configured so as to engage with each other.

19. The liquid tank according to claim 17, wherein
an intake for taking air into the housing is arranged in the housing.

20. The liquid tank according to claim 12, wherein
the housing has a through hole,
the deformable section is an elastic member which is arranged to seal the through hole from the inside of the housing, and
a restriction member for restricting a deformation amount of the deformable section so as not to exceed a certain deformation amount and that is arranged inside the housing.

21. A fuel cell including a power generation section and a fuel tank, the fuel tank comprising:
a housing containing a liquid fuel and having an outlet for feeding the liquid fuel to an outside of said housing;
a deformable section arranged in at least a part of the housing and being deformable by external pressure; and
a restriction means for restricting a deformation amount of the deformable section so as not to exceed a certain deformation amount.

22. An electronic apparatus mounting a fuel cell including a power generation section and a fuel tank, the fuel tank comprising:
a housing containing a liquid fuel and having an outlet for feeding the liquid fuel to an outside of said housing;
a deformable section arranged in at least a part of the housing and being deformable by external pressure; and
a restriction means for restricting a deformation amount of the deformable section so as not to exceed a certain deformation amount.
